(19) United States
(12) Patent Application Publication
(10) Pub. No.: US 2011/0298853 A1
(43) Pub. Date: Dec. 8, 2011

(54) PRINTING APPARATUS AND PROCESSING METHOD THEREOF

(75) Inventors: Hideaki Takamiya, Yokohama-shi (JP); Koichiro Nakazawa, Machida-shi (JP); Kanako Soma, Odawara-shi (JP)

(73) Assignee: CANON KABUSHIKI KAISHA, Tokyo (JP)

(21) Appl. No.: 13/112,264

(22) Filed: May 20, 2011

(30) Foreign Application Priority Data
Jun. 2, 2010 (JP) 2010-127312

(51) Int. Cl. B41J 29/38

(52) U.S. Cl. 347/13

(57) ABSTRACT

A printing apparatus includes a plurality of full-line type printheads. The printing apparatus holds information relating to overlap nozzles that overlap between a reference printhead and an adjustment printhead, generates discharge data for causing a tilt adjustment pattern to be printed by nozzles disposed in different positions in the overlap nozzles that overlap between the reference printhead and the adjustment printhead, and causes ink to be discharged from the nozzles in the overlap nozzles that overlap between the reference printhead and the adjustment printhead based on the discharge data. In this manner, the tilt adjustment pattern is printed on a printing medium.

### BACKGROUND OF THE INVENTION

1. Field of the Invention

The present invention relates to a printing apparatus and a processing method thereof.

2. Description of the Related Art

A printing apparatus employing an ink-jet printing system (hereinafter referred to as an “ink-jet printing apparatus”) is known. With such an ink-jet printing apparatus, ink is discharged from printing elements (nozzles) according to image signals and adhered to a printing medium, thereby printing an image on the printing medium.

An ink-jet printing apparatus that performs printing by using a printhead in which a plurality of printing elements (printing elements may be hereinafter referred to as “nozzles”) are integrally arrayed in an integrated manner, for example, in order to increase print speed is known. Also, an ink-jet printing apparatus including printheads for a plurality of colors in order to support color printing is known.

Due to recent advances in techniques for integrally arraying nozzles, a long and high-density printhead has been developed. Such a printhead is generally called a long full-line, multi-nozzle printhead (full-line, multi-nozzle printhead), which can complete printing of an image in a wide print region in a single print scanning.

A configuration of the full-line, multi-nozzle printhead is known in which a plurality of short print tips are arranged in a nozzle arrayed direction in parallel with each other, for example (see Japanese Patent Laid-Open No. 2004-224042). At this time, the short print tips are disposed in a staggered manner, while providing an overlapping portion between adjacent short print tips (hereinafter referred to as a “connecting portion”).

In this manner, generally, displacement in the disposition positions of the short print tips in the printhead often arises, which may cause displacement in the landing positions of ink drops discharged from nozzles. Such displacement deteriorates print quality.

In the case where the landing positions are adjusted in order to correct such displacement in the landing positions, it is difficult to detect the relative degree of displacement in tilt between different print tips. In the case of an ink-jet printing apparatus which performs printing while a short printhead is scanning over a printing medium a plurality of times, it is possible to detect the tilt condition of the printhead by printing a landing displacement check pattern at the same location with the leading portion and the trailing portion of the printhead. In contrast, with respect to the one-pass printing system in which printing is performed by a single scanning by using a long printhead, displacement in the landing position cannot be detected with the above-described method.

### SUMMARY OF THE INVENTION

The present invention provides a technique with which tilt between printheads can be detected even in a configuration in which a plurality of full-line type printheads are disposed so as to be displaced from each other in the nozzle arrayed direction.

According to a first aspect of the present invention there is provided a printing apparatus that includes a plurality of full-line type printheads in each of which a plurality of nozzle arrays are disposed in parallel with each other, the plurality of printheads being disposed so as to be displaced from each other in a nozzle arrayed direction so as to have overlap nozzles resulting from nozzles overlapping between the plurality of printheads in the nozzle arrayed direction, and performs printing by discharging ink from the nozzles of the plurality of printheads while moving a printing medium in a direction orthogonal to the nozzle arrayed direction, the printing apparatus comprising: a setting unit configured to set one of the plurality of printheads as a reference printhead; a holding unit configured to hold information relating to the overlap nozzles that overlap between the reference printhead set by the setting unit and an adjustment printhead whose tilt in the nozzle arrayed direction of the reference printhead is to be adjusted; a generation unit configured to generate discharge data for causing a tilt adjustment pattern to be printed by nozzles disposed in different positions in the overlap nozzles that overlap between the reference printhead and the adjustment printhead; and a print control unit configured to cause ink to be discharged from the nozzles in the overlap nozzles that overlap between the reference printhead and the adjustment printhead based on the discharge data generated by the generation unit, and causes the tilt adjustment pattern to be printed on the printing medium.

According to a second aspect of the present invention there is provided a processing method of a printing apparatus that includes a plurality of full-line type printheads in each of which a plurality of nozzle arrays are disposed in parallel with each other, the plurality of printheads being disposed so as to be displaced from each other in a nozzle arrayed direction so as to have overlap nozzles resulting from nozzles overlapping between the plurality of printheads in the nozzle arrayed direction, and performs printing by discharging ink from the nozzles of the plurality of printheads while moving a printing medium in a direction orthogonal to the nozzle arrayed direction, the method comprising: setting one of the plurality of printheads as a reference printhead; generating discharge data for causing a tilt adjustment pattern to be printed by nozzles disposed in different positions in the overlap nozzles that overlap between the set reference printhead and an adjustment printhead whose tilt in the nozzle arrayed direction of the reference printhead is to be adjusted based on information relating to the overlap nozzles that overlap between the reference printhead and the adjustment printhead; and causing ink to be discharged from the nozzles in the overlap nozzles that overlap between the reference printhead and the adjustment printhead based on the generated discharge data, and causing the tilt adjustment pattern to be printed on the printing medium.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram illustrating a configuration example of an ink-jet printing apparatus 1 according to an embodiment of the present invention.

FIG. 2 is a diagram illustrating an example of array of a printhead 2 shown in FIG. 1.

FIG. 3 is a diagram illustrating a configuration example of a control unit 9 of the printing apparatus 1 shown in FIG. 1.

FIG. 4 is a diagram illustrating a configuration example of the printhead 2 shown in FIG. 1.

FIGS. 5A to 5C are diagrams illustrating an outline of landing position adjustment in the printing apparatus 1 shown in FIG. 1.

FIG. 6 is a flowchart illustrating an example flow of landing position adjustment processing in the printing apparatus 1 shown in FIG. 1.

FIGS. 7A to 7F are diagrams illustrating an example outline of landing position adjustment in the printing apparatus 1 shown in FIG. 1.

FIG. 8 is a diagram illustrating a configuration example of a registration adjustment pattern.

FIG. 9 is a diagram illustrating a configuration example of tilt adjustment patterns.

FIG. 10 is a flowchart illustrating an example of a processing flow when the tilt adjustment patterns are printed with the printing apparatus 1 shown in FIG. 1.

FIG. 11 is a diagram illustrating a configuration example of a measurement device.

FIG. 12 is a diagram illustrating a configuration example of the tilt adjustment patterns.

FIGS. 13A and 13B are diagrams illustrating an example of disposition positions of printheads.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

Note that the following description will exemplify a printing apparatus which adopts an ink-jet printing system. The printing apparatus may be, for example, a single-function printer having only a printing function, or a multifunction printer having a plurality of functions including a printing function, FAX function, and scanner function. Also, the printing apparatus may be, for example, a manufacturing apparatus used to manufacture a color filter, electronic device, optical device, micro-structure, and the like using a predetermined printing system.

In this specification, “printing” means not only forming significant information such as characters or graphics but also forming, for example, an image, design, pattern, or structure on a printing medium in a broad sense regardless of whether the formed information is significant, or processing the medium as well. In addition, the formed information need not always be visualized so as to be visually recognized by humans.

In this specification, “printing” means not only forming significant information such as characters or graphics but also forming, for example, an image, design, pattern, or structure on a printing medium in a broad sense regardless of whether the formed information is significant, or processing the medium as well. In addition, the formed information need not always be visualized so as to be visually recognized by humans.

Also, “ink” should be interpreted in a broad sense as in the definition of “printing” mentioned above, and means a liquid which can be used to form, for example, an image, design, or pattern, process a printing medium, or perform ink processing upon being supplied onto the printing medium. The ink processing includes, for example, solidification or insolubilization of a coloring material in ink supplied onto a printing medium.

Also, a “nozzle” generically means an orifice, a liquid channel which communicates with it, and an element which generates energy used for ink discharge, unless otherwise specified.

### Embodiment 1

Apparatus Configuration

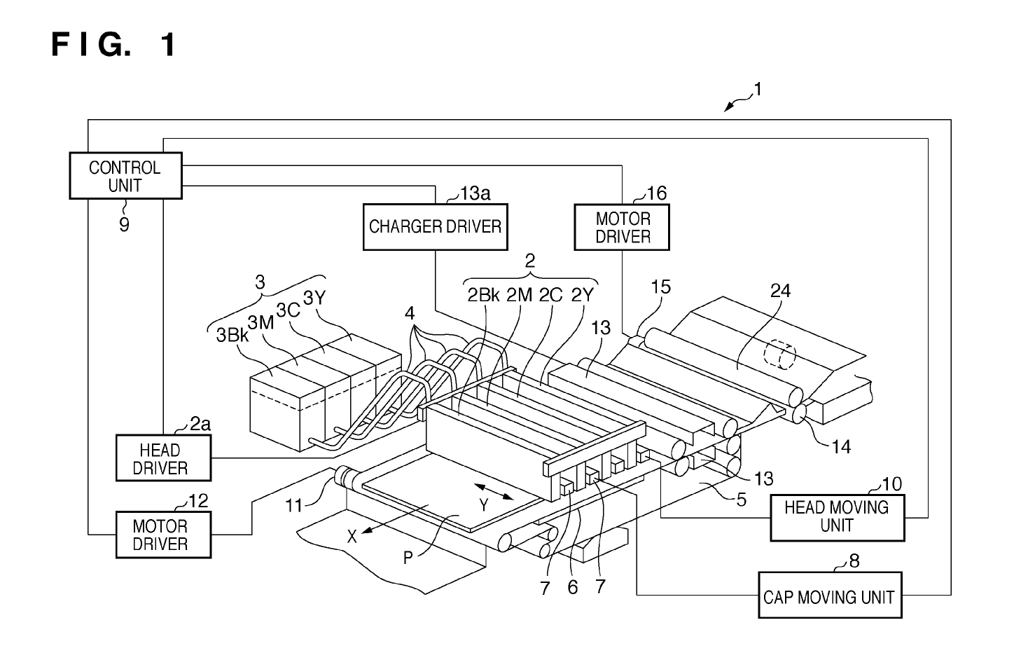

FIG. 1 is a diagram illustrating a configuration example of an ink-jet printing apparatus (hereinafter referred to as a “printing apparatus”) 1 according to an embodiment of the present invention.

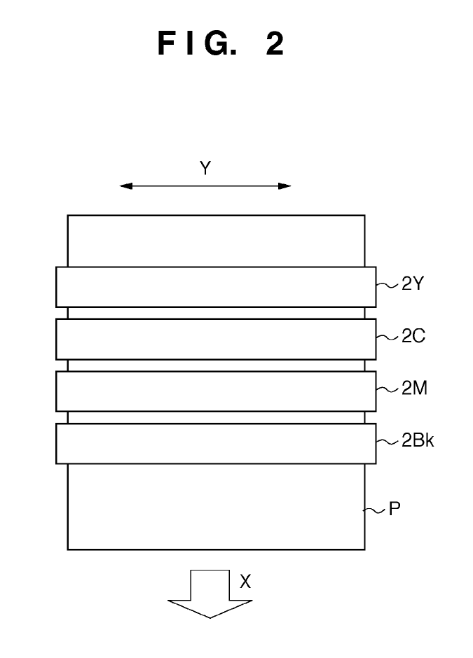

The printing apparatus 1 includes a so-called full-line type printhead 2 having a printing width corresponding to the width of a printing medium. A plurality of printheads 2 are provided corresponding to respective colors (2Y, 2M, 2C and 2Bk). Specifically, a printhead 2Y for discharging yellow ink, a printhead 2M for discharging magenta ink, a printhead 2C for discharging cyan ink, and a printhead 2Bk for discharging black ink are provided. These printheads are provided so as to extend in a direction (nozzle arrayed direction: Y direction) orthogonal to the conveyance direction (scanning direction: X direction) of a printing medium P, as shown in FIG. 2.

The printheads 2 are connected to four ink tanks, 3Y, 3M, 3C and 3Bk (hereinafter collectively referred to “ink tanks 3”), for storing yellow ink, magenta ink, cyan ink, and black ink, respectively, via connecting pipes 4. Each ink tank 3 can be independently detached.

The printheads 2 are disposed in a position facing a platen 6 with a conveyance belt 5 interposed therebetween. The printheads 2 are raised and lowered in a direction opposing the platen 6 by a head moving unit 10. Note that the operation of the head moving unit 10 is controlled by a control unit 9.

The printheads 2 include ink orifices for discharging ink, common liquid reservoirs to which ink from the ink tanks 3 is supplied, and ink channels (nozzles) for introducing ink from the common liquid reservoirs to the ink orifices. Each nozzle includes, for example, a printing element (hereinafter referred to as a “heater”) formed by a heating resistive element, a heater driving circuit and the like. The heater is electrically connected to the control unit 9 via a head driver 2a, and is driven/stopped according to an on/off signal (discharge/non-discharge signal) sent from the control unit 9. Note that various ink-jet printing systems can be employed for discharging ink other than the system using heaters, such as a system using piezoelectric elements, a system using electrostatic elements, and a system using MEMS elements.

Caps 7 are disposed on the side of the printheads 2 for performing recovery processing of the printheads 2, the caps 7 being disposed so as to be displaced by a half pitch with respect to the array interval of the printheads 2. The operation of a cap moving unit 8 is controlled by the control unit 9. The cap moving unit 8 causes the caps 7 to move to the position directly below the printheads 2, thereby causing the caps 7 to receive waste ink ejected from the ink orifices.

The conveyance belt 5 conveys the printing medium P, and is stretched across drive rollers connected to a belt driving motor 11. The operation of the conveyance belt 5 is switched by a motor driver 12.

A charger 13 is disposed on the upstream side of the conveyance belt 5. The charger 13 charges the conveyance belt 5, thereby causing the printing medium P to adhere to the conveyance belt 5. A charger driver 13a switches current supply to the charger 13 on/off. A pair of feed rollers including a feed roller 14 and a feed roller 24 feeds the printing medium P onto the conveyance belt 5. A feed motor 15 drives the pair of feed rollers 14 to rotate. The operation of the feed motor 15 is controlled by a motor driver 16.

The above is the description of a configuration example of the printing apparatus 1. Note that the configuration of the printing apparatus 1 shown in FIG. 1 is merely an example, and the configuration is not necessarily limited to such a configuration. For example, in the configuration in FIG. 1, although the printing medium P is conveyed with respect to the printheads 2, any configuration may be adopted as long as the printheads 2 and the printing medium P move relative to each other. For example, a configuration may be adopted in which the printheads 2 move with respect to the printing medium P.

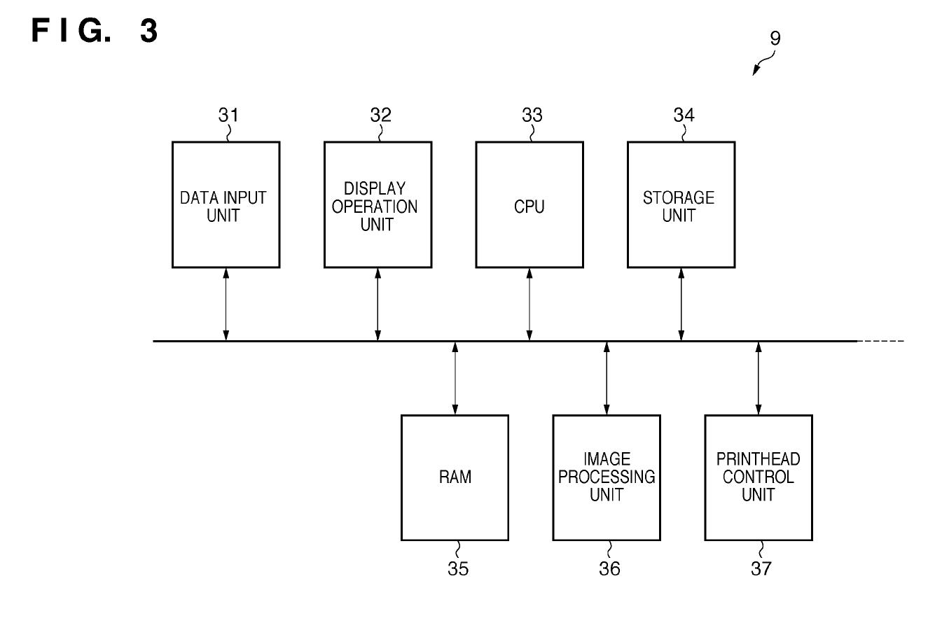

FIG. 3 is a diagram illustrating a configuration example of the control unit 9 shown in FIG. 1.

The control unit 9 includes a data input unit 31, a display operation unit 32, a CPU 33, a storage unit 34, a RAM 35, an image processing unit 36 and a printhead control unit 37 as functional elements. The data input unit 31 inputs multivalued image data from an image input device (e.g., digital camera, personal computer). The RAM 35 is used as a work area when the CPU 33 controls various programs, and temporarily stores various operation results, image processing results, and the like.

The display operation unit 32 is configured from an operation unit (e.g., touch panel, buttons) for inputting user instructions (e.g., parameter setting instruction, print start instruction) to the apparatus, and a display unit (e.g., a touch panel, display) for displaying various information to the user.

The CPU 33 performs overall control of the operation of the entire apparatus. For example, the CPU 33 controls operations of various units according to programs stored in the storage unit 34. The storage unit 34 stores various data. For example, information on the type of the printing medium, information on the ink, information on the environment such as temperature, humidity and the like, information on the correction of the landing position (registration adjustment information), information on the printheads 2, various control programs, and the like are stored in the storage unit 34.

The image processing unit 36 performs image processing on the multivalued image data input by the data input unit 31. For example, the image processing unit 36 quantizes the multivalued image data for each pixel into N-value image data, and assigns a dot arrangement pattern corresponding to a tone value “K” indicated by each quantized pixel. As a specific example, in the case of multivalued image data represented in 256 gradations, the tone values of the multivalued data are converted to K values. Note that a multi-level error diffusion method may be used for this processing, or an average density storage method, a dither matrix method, or any arbitrary halftone processing method may be used as well. Accordingly, the image processing unit 36 generates discharge data corresponding to each nozzle. When this discharge data is generated, the landing position of ink onto the printing medium is adjusted based on the registration adjustment information stored in the storage unit 34.

The printhead control unit 37 controls print operation by the printheads 2. The above is the description of a configuration example of the control unit 9. Note that the configuration of the control unit 9 is not necessarily limited to such a configuration. For example, part of the configuration may be realized by the CPU 33 loading a program stored in the storage unit 34 while using the RAM 35 as a work region and executing the program, or may be realized by a hardware configuration such as a dedicated circuit.

Configuration of Printheads

Next, a configuration example of the printheads 2 shown in FIG. 1 is described with reference to FIG. 4.

As described above, the printing width of the printheads 2 corresponds to the width of the printing medium. In each of the printheads 2, a plurality of print tips 41 are disposed uninterruptedly along the Y direction (nozzle arrayed direction), each print tip 41 being formed by disposing a plurality of nozzle arrays 42 in parallel with each other, and each nozzle array 42 being formed by arraying a plurality of nozzles. That is, a plurality of short print tips used in the serial type is connected in the Y direction, thereby enabling the printhead to be elongated.

The print tips 41 are disposed in the Y direction, and are disposed so as to be staggered in the X direction (scanning direction). The print tips 41 are disposed such that parts of the nozzle arrays (some of the nozzles) of print tips 41 that are adjacent in the X direction overlap.

The print tips 41 are disposed in the Y direction in a staggered manner, and thus, as described above, the portion where adjacent print tips overlap with each other in the Y direction (hereinafter referred to as a “connecting portion”) 43 is present between adjacent print tips. In this connecting portion 43, mask processing is performed, for example, so as to interpolate dots between adjacent print tips to prevent white and black streaks.

Also, the printheads (two in this example) are disposed displaced from each other in the Y direction. In the connecting portion 43, print results may deteriorate due to an effect of attachment accuracy or attachment error of the print tips 41, and the like. Therefore, if the connecting portions corresponding to different colors overlap with each other, further deterioration in the print results occurs. In view of this, the printheads 2 are disposed displaced from each other in the Y direction such that the connecting portions 43 of the respective printheads 2 do not overlap with each other.

The above is the description of a configuration of the printheads 2. The configuration of the printheads 2 shown in FIG. 4 is merely an example, and it is not always necessary to adopt such a configuration. That is, it is sufficient if the printheads 2 of Embodiment 1 are disposed displaced from each other in the Y direction, and there is no restriction to other specific configurations thereof.

General Processing of Landing Position Adjustment

Next, the landing position adjustment (registration adjustment) processing in the printing apparatus 1 shown in FIG. 1 is described. Note that registration adjustment processing is performed by the user giving an instruction therefor when the printheads 2 are replaced, for example. Note that a configuration may be adopted in which the apparatus automatically detects replacement of the printheads 2 and performs registration adjustment processing.

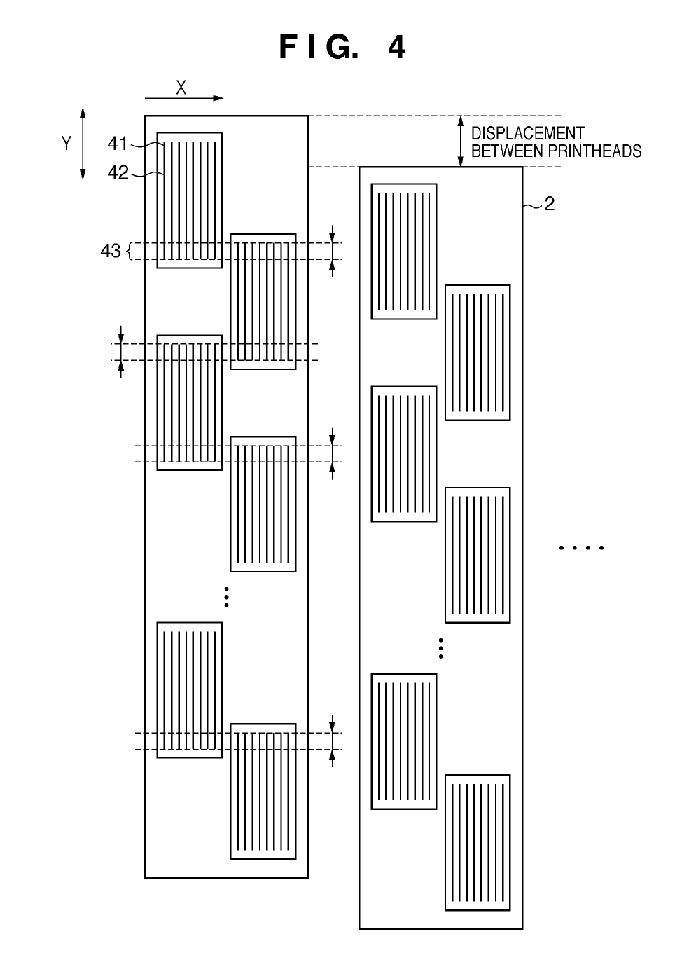

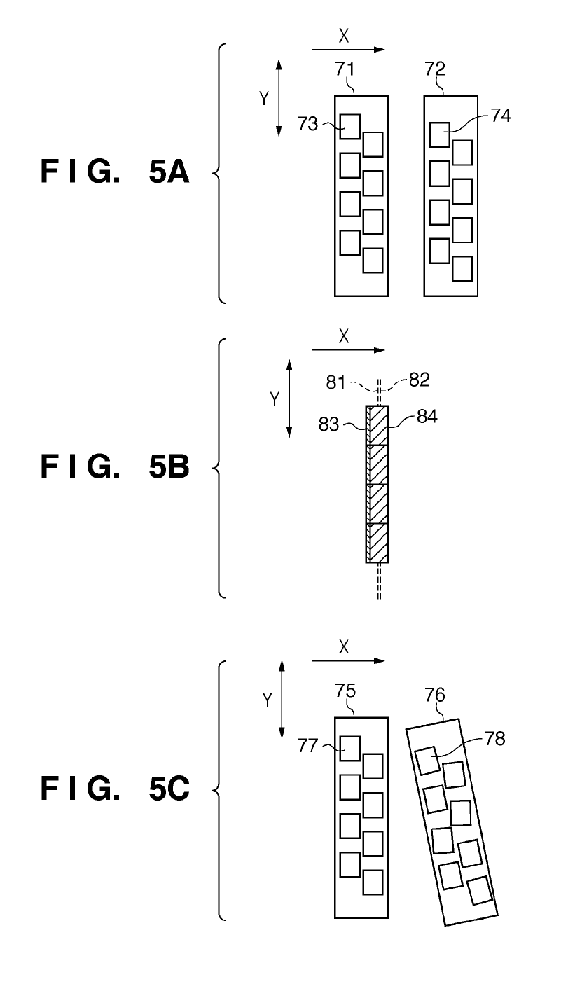

First, registration adjustment is briefly described. FIG. 5A shows a plurality (two rows in this example) of printheads 71 and 72. A plurality of print tips 73 and a plurality of print tips 74 are disposed in the printheads 71 and 72, respectively. The positional relationship of the printheads 71 and 72 and the plurality of print tips 73 and 74 respectively disposed therein, and the positional relationship between the print tips are both ideal.

FIG. 5B shows the relationship between the print position on the printing medium by the printhead 71 and that by the printhead 72. A line segment 81 is the center line of the printhead 71, and a line segment 82 is the center line of the printhead 72. A region 83 is the print position on the printing medium by the plurality of print tips 73, and a region 84 is the print position on the printing medium by the plurality of print tips 74. If the printheads and print tips are disposed in an ideal positional relationship, the print results as shown in FIG. 5B are obtained.

In contrast, in the case of FIG. 5C, for example, where there is a displacement in the positional relationship of printhead 75 and printhead 76 and print tips 77 and print tips 78, or in the positional relationship between the print tips, ideal print results as shown in FIG. 5B cannot be obtained. Therefore, in Embodiment 1, registration adjustment is performed to perform correction in order to obtain ideal print results.

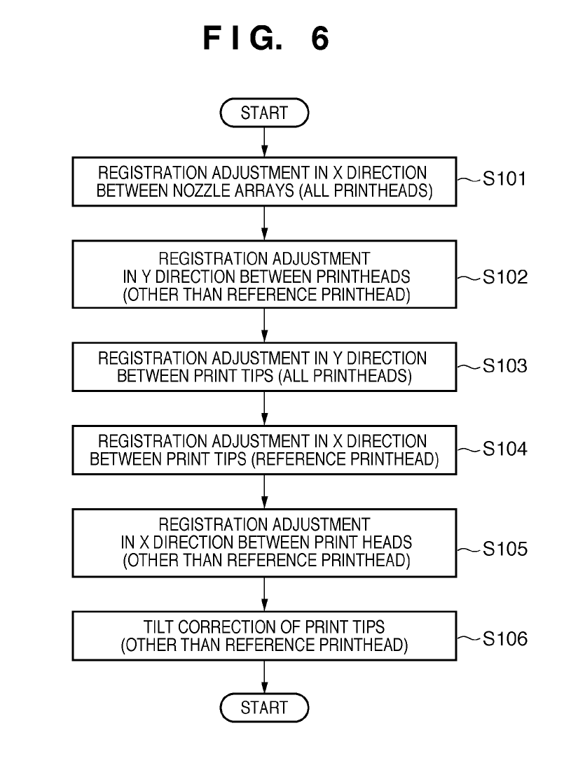

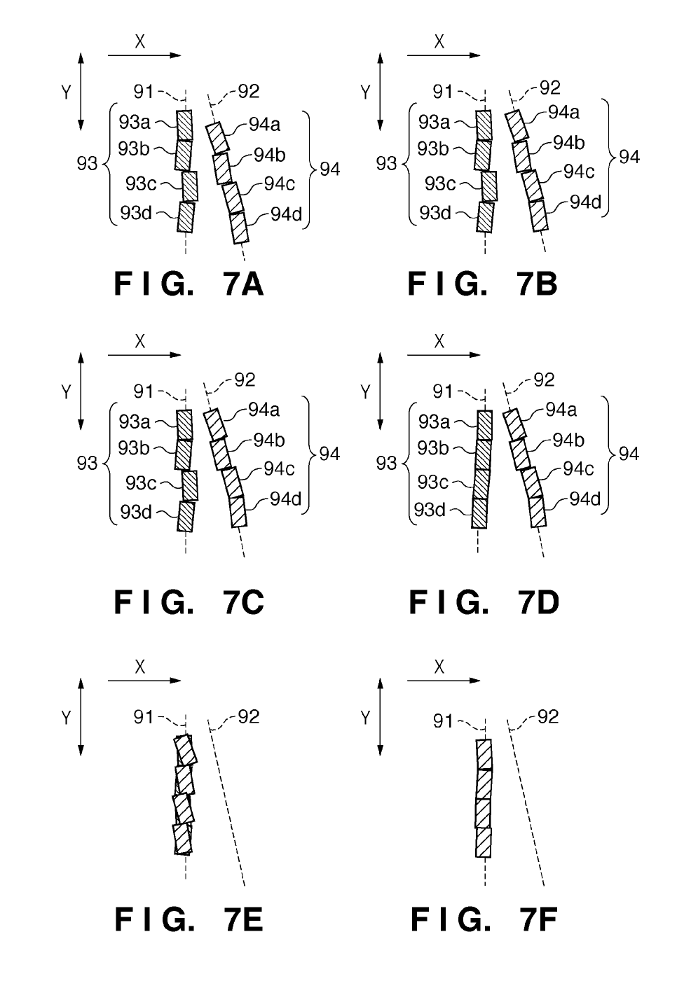

Here, registration adjustment processing is described with reference to FIG. 6 and FIGS. 7A to 7F. FIG. 6 shows a flowchart illustrating an example flow of the registration adjustment processing. FIGS. 7A to 7F show the print positions on the printing medium by the printheads 75 and 76 shown in FIG. 5C. A line segment 91 is the center line of the printhead 75, and a line segment 92 is the center line of the printhead 76. Regions 93 (93a to 93d) represent the print positions on the printing medium by the plurality of print tips 77, and regions 94 (94a to 94d) represent the print positions on the printing medium by the plurality of print tips 78. Note that before the registration adjustment is performed, the print results obtained by the printheads 75 and 76 are as shown in FIG. 7A.

In the registration adjustment processing, first, registration adjustment (displacement correction) in the X direction between the nozzle arrays is performed (step S101). Specifically, the displacement in the X direction between the nozzle arrays is corrected in all the printheads by discharge timing control.

Next, registration adjustment in the Y direction between the printheads (inter-color registration adjustment in the Y direction) is performed (step S102). In this step, a printhead that serves as a reference (reference printhead) is set, and adjustment is performed by aligning other printheads to the reference printhead. As shown in 7B, the printhead 75 (center line 91) is set as a reference, for example, and all of the data of the other printheads is displaced in the Y direction so as to be aligned with a print tip 77 (93a) located at the end of the printhead 75 (upper end in FIG. 7B). In this manner, the position in the Y direction of each printhead is adjusted.

Next, registration adjustment in the Y direction between the print tips is performed (step S103). In this step, as shown in FIG. 7C, the print tip 77 (93a) and a print tip 78 (94a) located at the end portion (upper end in FIG. 7C) of each printhead are set as references, and the Y-direction position of each print tip is adjusted.

Then, registration adjustment in the X direction between the print tips is performed (step S104). This processing is performed only on the reference printhead 75 (center line 91). As shown in FIG. 7D, the position in the X direction between adjacent print tips is adjusted. Note that this processing is performed by controlling the discharge timing.

Then, registration adjustment in the X direction between the printheads (inter-color registration adjustment in the X direction) is performed (step S105). This processing is performed on printheads other than the reference printhead 75 (center line 91). As shown in FIG. 7E, each of printheads other than the reference printhead adjusts the positions in the X direction of the print tips therein so as to be aligned to the positions of the print tips in the reference printhead. In this processing, different correction values are set for the respective print tips. Note that this processing is performed by controlling the discharge timing.

Lastly, tilt of the print tips is adjusted (step S106). This processing is performed on printheads other than the reference printhead 75 (the center line 91). As shown in FIG. 7F, each of printheads other than the reference printhead corrects the tilt of the print tips therein with respect to the corresponding print tips 77 (93a to 93d) of the reference printhead 75 (center line 91). This correction is performed by shifting the column of the discharge timing only for the data with respect to which the print position of the print tip is displaced by one pixel or more from the print position of the reference printhead 75 (center line 91).

Landing Position Check Pattern

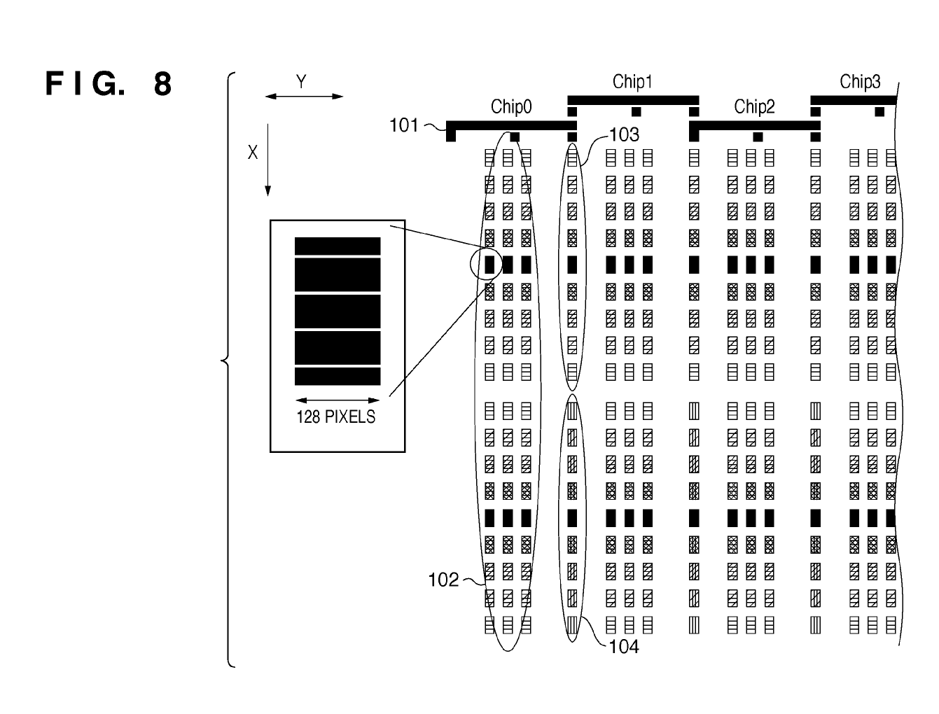

Next, the method for detecting the adjustment value (displacement amount) at the time of registration adjustment is described. First, a registration adjustment pattern is described. The registration adjustment pattern is a check pattern for adjusting registration between the nozzle arrays and the print tips, and is realized by, for example, the layout shown in FIG. 8. Note that the registration adjustment pattern is printed based on a user instruction given through the display operation unit 32 of the printing apparatus 1.

The registration adjustment pattern includes alignment marks 101. The alignment marks 101 are formed for detecting respective patterns, and the positions of these patterns can be determined by recognizing the alignment marks.

Here, the registration adjustment pattern includes, corresponding to an alignment mark (each print tip) 101, a registration adjustment pattern 102 for adjustment between the nozzle arrays, and a registration adjustment pattern 103 for adjustment in the X direction between the print tips. Also, the registration adjustment pattern includes a registration adjustment pattern 104 for adjustment in the Y direction between the print tips.

How these registration adjustment patterns are formed is described. In order to form the registration adjustment patterns, first, a first pattern is printed by the reference nozzle array, and a second pattern is printed by the nozzle array that serves as a landing position displacement detection target. Accordingly, on the stripe pattern printed by using the reference nozzle array, a pattern that interpolates the stripe pattern is printed.

Printing of the pattern by the nozzle array that serves as a landing position displacement detection target is performed at the position displaced by one pixel from the first pattern, by controlling the discharge timing. Here, if the landing position is an ideal position, stripe patterns mutually interpolate and causes no gap between the patterns. That is, when the patterns are read by a reading device such as a scanner, the detected density of the pattern formed with ideal landing positions is the highest. Displacement in the landing position is detected by using these patterns.

Tilt Adjustment Pattern

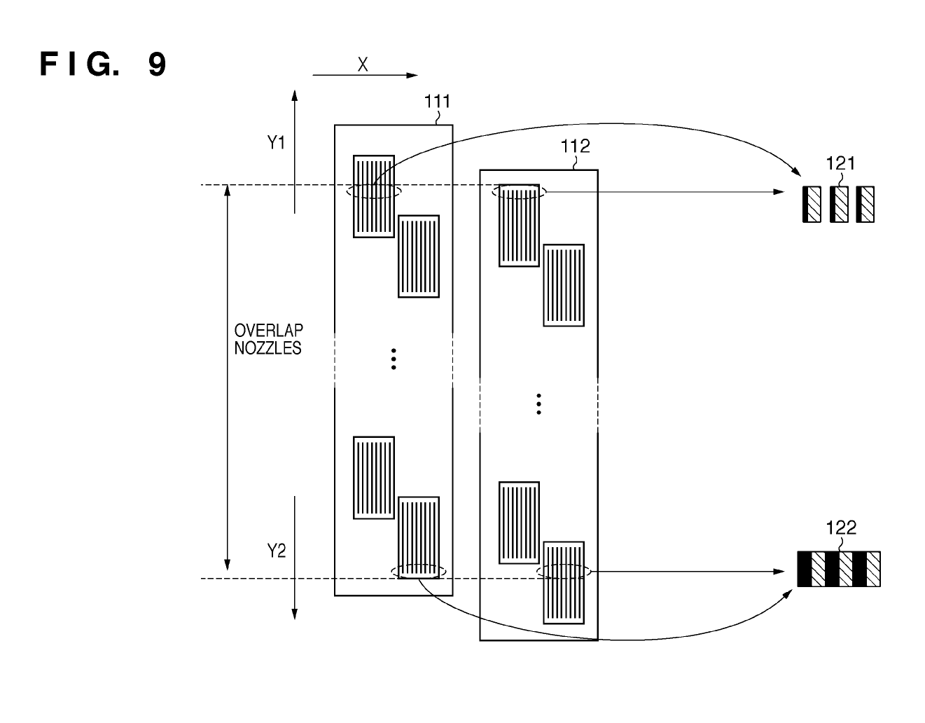

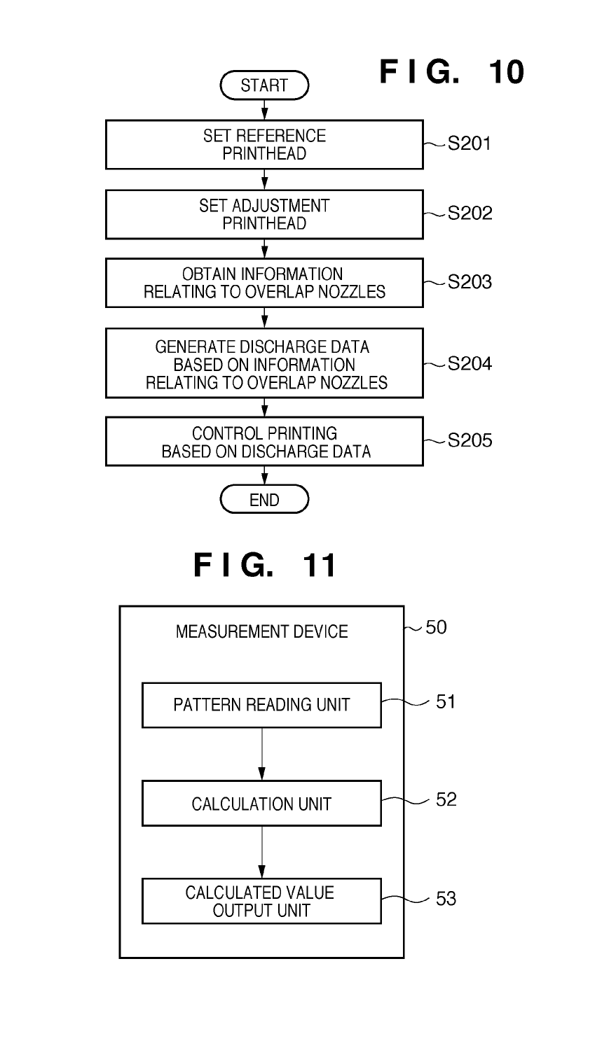

Next, an example of a tilt adjustment pattern is described with reference to FIG. 9.

FIG. 9 shows a printhead serving as a reference (reference printhead) 111, and a printhead (adjustment printhead) 112 serving as a tilt adjustment target with respect to the nozzle arrayed direction of the reference printhead 111. The adjustment printhead 112 is disposed displaced in the Y direction with respect to the reference printhead 111. For example, in the case where 512 nozzles are disposed in the Y direction on the printhead, the printheads are disposed displaced from each other by 128 nozzles in the Y direction. The two printheads are disposed with 384 nozzles thereof overlapping each other.

In order to detect the tilt between the reference printhead 111 and the adjustment printhead 112, patterns are printed by using nozzles in at least two locations in overlap nozzles (a region where the nozzle arrays of printheads overlap with each other: 384 nozzles in this example). As a favorable example of this, FIG. 9 shows a state in which patterns 121 and 122 are printed by using the nozzles positioned at both ends of the overlap nozzles between the reference printhead 111 and the adjustment printhead 112. It is possible to detect tilt with a highest accuracy by printing the patterns with nozzles at the ends of the overlap nozzles and detecting displacement in the landing positions based on the patterns.

Here, for example, when displacement in the landing position is measured based on two locations, namely, the patterns 121 and 122, the displacement in the landing position in the pattern 121 is detected by using the pattern 122 as a reference point. At this time, it is assumed that the pattern 121 is relatively displaced from the pattern 122 by one pixel in 1200 dpi units (21 μm). In such a case, it is considered that with respect to the length corresponding to 384 nozzles, there is one-pixel displacement in the direction orthogonal to the length direction. As a result, the tilt is detected to be approximately 0.15 degrees.

Then, the tilt of each printhead is corrected based on the detected value (tilt). As a method for correcting tilt, a conventional method can be used, and thus a description of the method is omitted. For example, tilt may be corrected by a technique disclosed in Japanese Patent Laid-Open Nos. 2007-326315, 11-240143, for example.

Printing of Tilt Adjustment Pattern

Next, an example flow of processing when the tilt adjustment pattern is printed is described with reference to FIG. 10.

In this processing, first, the printing apparatus 1 sets a reference printhead and (one or plural) adjustment printheads in the CPU 33 (steps S201 and S202). The reference printhead may be set based on the setting information held in the storage unit 34 in advance, or may be set based on a user instruction given via the display operation unit 32. The adjustment printhead may be automatically set by the apparatus, or may be set based on the user instruction given via the display operation unit 32.

Next, the printing apparatus 1 obtains information relating to the printhead (overlap nozzles) from the storage unit 34, in the CPU 33 (step S203). That is, the printing apparatus 1 obtains information indicating the relationship in which nozzles of a plurality of printheads are disposed overlapping each other in the Y direction.

After the information is obtained, the printing apparatus 1 generates discharge data for causing the reference printhead and the adjustment printhead to print the tilt adjustment patterns with the image processing unit 36 (step S204). That is, the printing apparatus 1 generates discharge data for printing the tilt adjustment patterns shown in FIG. 9.

After the discharge data is generated, the printing apparatus 1 causes ink to be discharged from nozzles of the reference printhead and the adjustment printhead with the printhead control unit 37, thereby printing the tilt adjustment patterns on the printing medium (step S205). This print control is performed based on the discharge data generated in step S205.

Configuration of Measurement Device

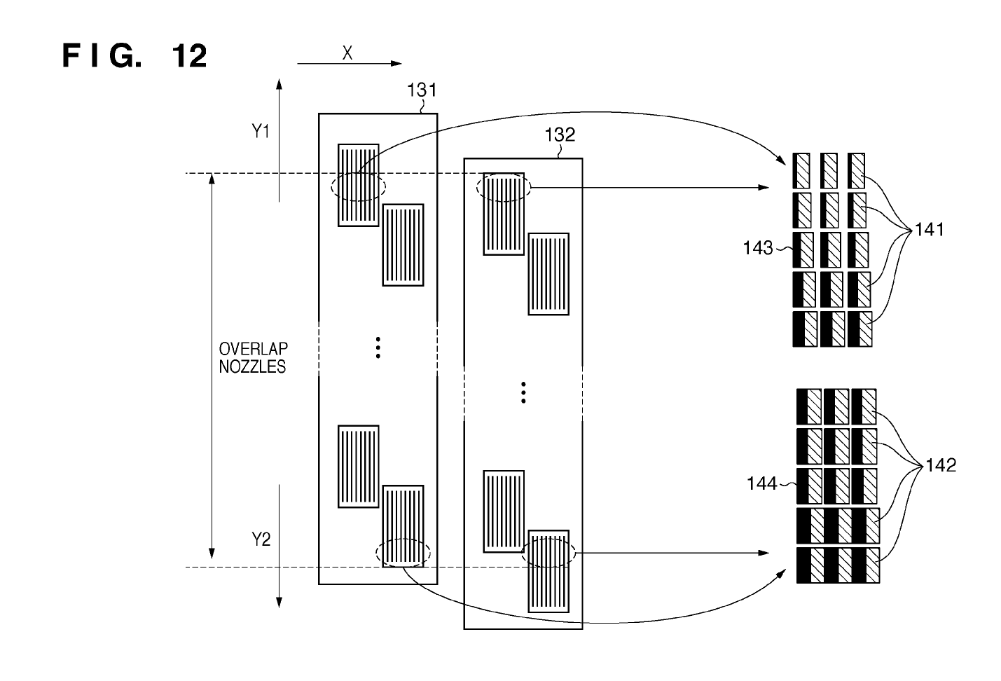

Next, a configuration example of a measurement device 50 is described with reference to FIG. 11.

The measurement device 50 calculates a displacement amount between printheads, a displacement amount between print tips, and a displacement amount between a printhead and the print tips therein, based on the registration adjustment pattern shown in FIG. 8 and the tilt adjustment patterns shown in FIG. 9.

Here, the measurement device 50 is configured from a pattern reading unit 51, a calculation unit 52 and a calculated value output unit 53.

The pattern reading unit 51 reads the registration adjustment pattern shown in FIG. 8 and the tilt adjustment patterns shown in FIG. 9. The calculation unit 52 calculates calculated values (displacement amounts) based on the reading results of the patterns. Also, the calculated value output unit 53 outputs the displacement amount calculated by the calculation unit 52 to the printing apparatus 1. Accordingly, the printing apparatus 1 generates discharge data with the image processing unit 36, while taking the displacement amount into account.

Note that the calculation unit 52 may calculate not only the displacement amount, but also an adjustment value used for correcting displacement. Here, a case is considered in which the adjustment value is calculated based on the patterns 121 and 122 read from the tilt adjustment patterns shown in FIG. 9. In such a case, distance information in the Y direction between the nozzles used for printing the patterns 121 and 122 (in this case, the distance corresponding to 384 nozzles) and the like is held in advance in the measurement device (unshown storage unit). With such a configuration, it is possible to calculate the displacement amount, and calculate the adjustment value based on the calculation results, the distance information, and the like.

Also, the measurement device 50 may be provided in the printing apparatus 1, or may be provided as a stand-alone device. Furthermore, part of the functions realized by the measurement device 50 may be provided in the printing apparatus 1. For example, a configuration may be adopted in which the pattern reading unit 51 is provided in the printing apparatus 1, and other units are provided in another apparatus.

As described above, with Embodiment 1, tilt between the printheads is detected by printing the tilt adjustment patterns by using nozzles at the end portions of the overlap nozzles. In this manner, the tilt between printheads can be detected even in a configuration in which a plurality of full-line type printheads is disposed displaced from each other in the Y direction.

### Embodiment 2

Next, Embodiment 2 is described. With printing apparatuses employing an ink-jet printing system, generally, a phenomenon in which the landing positions at the end portions of the printhead shift inwardly may occur. This phenomenon occurs due to disturbed airflow caused by relative movement of the printhead or printing medium. Thus, in Embodiment 2, tilt is detected at portions other than end portions, where there is less shift in the landing position due to such airflow caused by the apparatus itself.

The patterns in Embodiment 2 are described in detail with reference to FIG. 12.

Patterns 141 and patterns 142 are dummy patterns, which are not used for tilt detection.

Patterns 143 and 144 are used for tilt detection. That is, while printing the dummy patterns by using nozzles positioned at the end portions of the overlap nozzles, the tilt adjustment patterns 143 and 144 are printed by using nozzles in a portion other than the end portions. Accordingly, even if airflow occurs, tilt adjustment patterns 143 and 144 are not affected by the airflow. As described above, with Embodiment 2, even if disturbed airflow occurs due to the printheads or the printing medium relatively moving, tilt between the printheads can be precisely detected.

### Embodiment 3

Next, Embodiment 3 is described. In Embodiment 3, the disposition positions in the Y direction of a plurality of printheads are described.

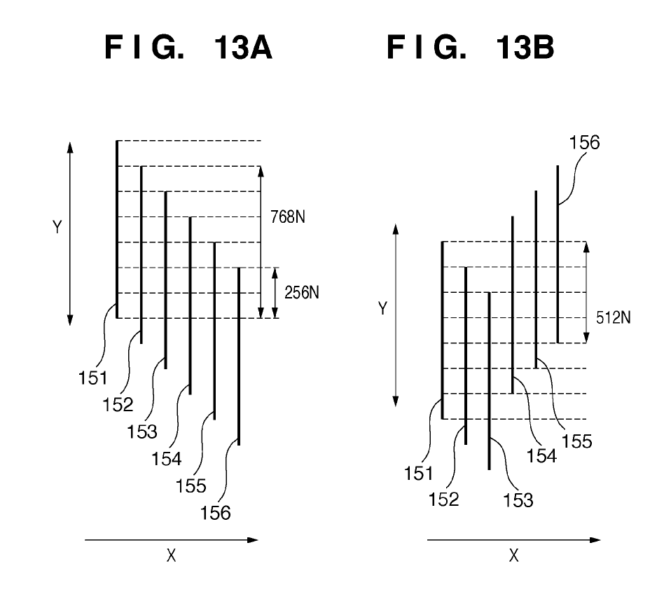

FIGS. 13A and 13B are diagrams illustrating the relationship of the disposition positions in the Y direction of the printheads. Note that each printhead is assumed to include 996 nozzles in the Y direction.

In the case of FIG. 13A, the printheads of the respective colors are disposed sequentially displaced by 128 nozzles in the Y direction. In this case, for example, a printhead 151 and a printhead 152 have 768 overlap nozzles. In contrast, the printhead 151 and a printhead 157 have 256 overlap nozzles. If the number of overlap nozzles differ among the colors, even if tilt is detected based on the patterns formed in at least two locations in the overlap nozzle region, detection accuracy differs among the colors.

Then, with Embodiment 3, as shown in FIG. 13B, the printhead serving as a reference is disposed in the center position in the Y direction. In such a case, the number of overlap nozzles between the reference printhead and the printheads of the respective colors increases. That is, the reference printhead 151 has at least 512 overlap nozzles with the printhead of any color. Therefore, it is possible to detect tilt for any color with good accuracy. The reference printhead 151 achieves the largest number of overlap nozzles with other printheads in the case of FIG. 13B.

Although typical embodiments of the present invention are described above as examples, the present invention is not limited to the embodiments described above or illustrated in the drawings, and can be appropriately modified without departing from the gist of the present invention.

Note that in the foregoing embodiments, a case is described as an example in which displacement in the landing position is detected based on the stripe patterns printed by the nozzle arrays serving as the landing position displacement detection targets interpolating each other, although the patterns are not limited thereto. For example, the pattern may be a pattern such as the scale of a slide caliper, a pattern in which displacement in the landing position is detected by using optical equipment such as a scanner, or a pattern with which the positional displacement can be read visually and input.

Also, although the foregoing embodiments do not refer to the ink amount of ink droplets discharged from the nozzle arrays, a printhead may include nozzles capable of discharging ink droplets in different ink amounts. Also, in addition to yellow, cyan, magenta and black inks, inks that are in the same hue but have different densities may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-127312, filed Jun. 2, 2010, which is hereby incorporated by reference herein in its entirety.

What is claimed is:

1. A printing apparatus that includes a plurality of full-line type printheads in each of which a plurality of nozzle arrays are disposed in parallel with each other, the plurality of printheads being disposed so as to be displaced from each other in a nozzle arrayed direction so as to have overlap nozzles resulting from nozzles overlapping between the plurality of printheads in the nozzle arrayed direction, and performs printing by discharging ink from the nozzles of the plurality of printheads while moving a printing medium in a direction orthogonal to the nozzle arrayed direction, the printing apparatus comprising:
a setting unit configured to set one of the plurality of printheads as a reference printhead;
a holding unit configured to hold information relating to the overlap nozzles that overlap between the reference printhead set by the setting unit and an adjustment printhead whose tilt in the nozzle arrayed direction of the reference printhead is to be adjusted;
a generation unit configured to generate discharge data for causing a tilt adjustment pattern to be printed by nozzles disposed in different positions in the overlap nozzles that overlap between the reference printhead and the adjustment printhead; and
a print control unit configured to cause ink to be discharged from the nozzles in the overlap nozzles that overlap between the reference printhead and the adjustment printhead based on the discharge data generated by the generation unit, and causes the tilt adjustment pattern to be printed on the printing medium.

2. The printing apparatus according to claim 1,
wherein the generation unit generates discharge data for causing nozzles positioned at both ends of the overlap nozzles that overlap between the reference printhead and the adjustment printhead to perform printing.

3. The printing apparatus according to claim 1,
wherein the generation unit generates discharge data for causing nozzles positioned at both ends of the overlap nozzles that overlap between the reference printhead and the adjustment printhead and nozzles in a position other than both ends to perform printing.

4. The printing apparatus according to claim 1,
wherein a printhead having a largest number of overlap nozzles that overlap with another printhead is set as the reference printhead.

5. The printing apparatus according to claim 1,
wherein each of the printheads includes a plurality of print tips in each of which a plurality of nozzle arrays are disposed in parallel with each other,
the plurality of print tips are disposed in the nozzle arrayed direction and such that some of the plurality of nozzles included in print tips that are mutually adjacent out of the plurality of print tips overlap each other in the nozzle arrayed direction.

6. The printing apparatus according to claim 1 further comprising an adjustment unit configured to adjust a landing position on a printing medium of ink discharged from nozzles in the reference printhead and the adjustment printhead, based on an adjustment value calculated based on a result of reading the tilt adjustment pattern.

7. A processing method of a printing apparatus that includes a plurality of full-line type printheads in each of which a plurality of nozzle arrays are disposed in parallel with each other, the plurality of printheads being disposed so as to be displaced from each other in a nozzle arrayed direction so as to have overlap nozzles resulting from nozzles overlapping between the plurality of printheads in the nozzle arrayed direction, and performs printing by discharging ink from the nozzles of the plurality of printheads while moving a printing medium in a direction orthogonal to the nozzle arrayed direction, the method comprising:
setting one of the plurality of printheads as a reference printhead;
generating discharge data for causing a tilt adjustment pattern to be printed by nozzles disposed in different positions in the overlap nozzles that overlap between the set reference printhead and an adjustment printhead whose tilt in the nozzle arrayed direction of the reference printhead is to be adjusted based on information relating to the overlap nozzles that overlap between the reference printhead and the adjustment printhead; and
causing ink to be discharged from the nozzles in the overlap nozzles that overlap between the reference printhead and the adjustment printhead based on the generated discharge data, and causing the tilt adjustment pattern to be printed on the printing medium.
